(19) United States
(12) Patent Application Publication
(10) Pub. No.: US 2016/0096412 A1
(43) Pub. Date: Apr. 7, 2016

(54) PASSENGER CABIN INTERIOR ENVIRONMENT MONITORING SYSTEM

(71) Applicant: GM GLOBAL TECHNOLOGY OPERATIONS LLC, DETROIT, MI (US)

(72) Inventors: NILESH D. MANKAME, ANN ARBOR, MI (US); NANCY L. JOHNSON, NORTHVILLE, MI (US); DONALD K. GRIMM, UTICA, MI (US)

(21) Appl. No.: 14/507,413

(22) Filed: Oct. 6, 2014

(51) Int. Cl. B60H 1/00

(52) U.S. Cl. CPC B60H 1/00792; B60H 1/008; B60H 1/00978; B60H 1/00985; B60H 1/00735

(57) ABSTRACT

A system and method for monitoring environmental conditions in an interior portion of a vehicle. The system and method include a plurality of sensors that monitor environmental conditions in the interior portion of the vehicle and a controller that is programmed to receive sensor signals and compile indexes based on one or more of the sensor signals, built-in control logic and a history of user preferences. The controller is further programmed to determine if one or more predetermined threshold environmental conditions have been reached and to provide countermeasures when one or more of the predetermined thresholds has been reached.

### BACKGROUND OF THE INVENTION

1. Field of the Invention

This invention relates generally to a system and method for monitoring passenger cabin environment of a vehicle and, more particularly, to a system and method that monitors various environmental conditions in a passenger cabin of the vehicle and that provides escalating countermeasures based on changes in the environmental conditions and response, or lack thereof, from a user.

2. Discussion of the Related Art

Modern vehicles employ various sensors to monitor a wide variety of vehicle conditions, including temperature in a passenger cabin of a vehicle. The comfort and safety of the passenger cabin is a priority for consumers and there are many reasons to monitor a vehicle's interior environment that range from, for example, passenger comfort and safety to protecting perishable items such as groceries that may be in the vehicle. Such a monitoring system would be particularly useful for an occupant that is left in a vehicle and unable to remedy an inhospitable condition. Thus, there is a need in the art for a monitoring system that determines when the vehicle's interior cabin environment is inhospitable so that occupants and items in the vehicle are protected from adverse effects that may result from such an environment.

### SUMMARY OF THE INVENTION

The following disclosure describes a system and method for monitoring environmental conditions in an interior portion of a vehicle. The system and method include a plurality of sensors that monitor environmental conditions in the interior portion of the vehicle and a controller that is programmed to receive sensor signals and compile indexes based on one or more of the sensor signals, built-in control logic and a history of user preferences. The controller is further programmed to determine if one or more predetermined threshold environmental conditions have been reached and to provide countermeasures when one or more of the predetermined thresholds has been reached.

Additional features of the present invention will become apparent from the following description and appended claims, taken in conjunction with the accompanying drawings.

### BRIEF DESCRIPTION OF THE DRAWINGS

FIG. 1 is an illustration of a vehicle with a passenger cabin interior environment monitoring system; and

FIG. 2 is a flow diagram of a method for using the passenger cabin interior environment monitoring system.

### DETAILED DESCRIPTION OF THE EMBODIMENTS

The following discussion of the embodiments of the invention directed to a system and method for a passenger cabin interior environment monitoring system is merely exemplary in nature, and is in no way intended to limit the invention or its applications or uses. For example, while a vehicular application is discussed, the system and method described herein may be used to monitor other environments.

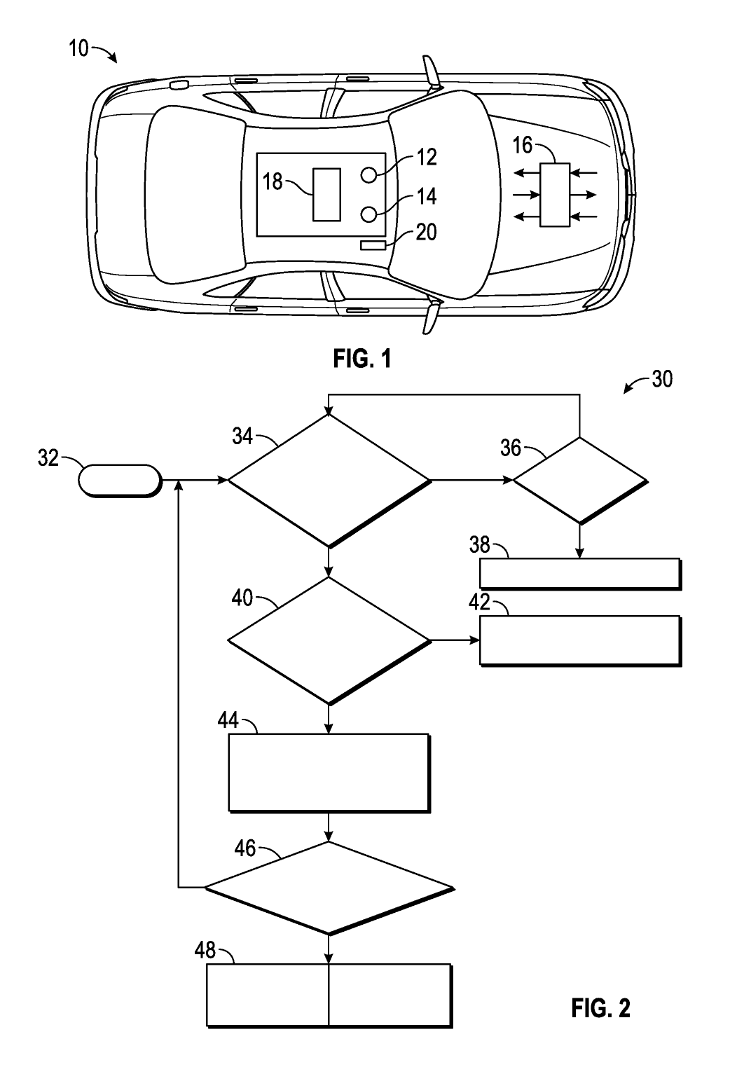

FIG. 1 is an illustration of a vehicle 10 with a cut-away roof portion that includes sensors 12 and 14 that are intended to represent a variety of sensors that may be used in connection with monitoring a vehicle's interior passenger cabin environment. For example, the sensors 12 and 14 may include sensors that monitor temperature, oxygen, carbon monoxide, carbon dioxide, ultraviolet radiation, allergens, the presence of an occupant and/or the presence of items within the vehicle, including items in the interior cabin or trunk. A controller 16 receives signals from the sensors 12 and 14, and also receives and sends signals to a human-machine interface (HMI) 18. The HMI 18 may be part of the vehicle 10 or may be a handheld device, computer, etc., that the controller 16 communicates with via a communications device 20. The communications device 20 also allows the vehicle to communicate with other devices such as phones and OnStar®.

The controller 16 may extrapolate certain conditions of the interior cabin of the vehicle 10 instead of requiring sensor signals for certain conditions, such as temperature. The sensors 12 and 14 feed into the controller 16 as stated above, and the controller 16 includes an estimating unit that escalates corrective actions based on changes in the interior conditions, the rates of change of the interior conditions and response (or lack thereof) from a user, as described in more detail below. The relevant sensors, e.g., the sensors 12 and 14, may not be able to sample and/or communicate with the controller 16 in time to take corrective action if the environment attribute/condition is changing quickly or if a relevant sensor/communication line is busy with some other higher priority information exchange. Thus, it is important that the controller 16 has built-in logic that is capable of, for example, estimating a future value of a vehicle environment attribute based on, for example, a current sensor value, a rate of change of the current sensor value, relevant exterior environment attributes and their rates of change, forecasts for changes in the exterior environment (e.g., weather reports, location estimation based on travel plans, etc.). As an example, the controller 16 may decide to cool the car at a slower rate on a summer night in preparation for a morning commute if the weather forecast includes thunderstorms in a pre-dawn period.

The sensors 12 and 14 may include existing sensors, such as sensors in an HVAC line, and the sensors 12 and 14 may also include added sensors that monitor the interior cabin of the vehicle 10. For example, the sensors 12 and 14 may be embedded sensors, a plug-in sensor device, or a device with a usable sensor that is paired/associated with the vehicle 10 such as a smart watch with an oxygen sensor. This flexible system architecture allows user-installed sensing devices to monitor the interior cabin of the vehicle 10 and the controller 16 to acquire sensor readings therefrom. For example, a variety of low cost, battery powered Bluetooth low energy devices may be used.

Data collected from the sensors 12 and 14 is compiled by the controller 16 into one or more indexes. For example, the index may be a scale of 0-5 where 0 is considered inhospitable and 5 is considered comfortable. Temperature and air quality, for example, may be monitored using the indexes, and the vehicle 10 may send notifications and/or may take corrective action(s) if any of the indexes go outside of specified thresholds, as described in more detail below. The specified thresholds of the indexes may be preset by the vehicle manufacturer, may be set by a vehicle occupant using the HMI 18 or may be set by a vehicle user remotely using, for example, OnStar®, RemoteLink®, a computer, smart phone, smart watch, or a similar device equipped with a suitable application. The user may also enable or disable the thresholds using the HMI 18 or a suitable remote device. This may be useful in circumstances where a vehicle is left for long periods of time, such as when a driver is on vacation. As stated above, information collected from the sensors 12 and 14 may be used to diagnose and preempt unsafe environmental conditions in the passenger cabin of the vehicle 10. This is particularly useful for occupants with cognitive, sensory or motor skill impairments, such as the elderly and the very young, and accidental death of such persons may be avoided, e.g., the child or pet left in a hot car scenario.

FIG. 2 is a flow diagram 30 of a non-limiting algorithm that is programmed into the controller 16 for monitoring the interior environment of the passenger cabin of the vehicle 10. Other algorithms/processes may be equally applicable to the scope of the invention described herein. The algorithm begins at box 32, and the algorithm determines if there is an environmental condition that indicates an inhospitable passenger cabin environment at decision diamond 34. If not, it is possible that the reason is because the passenger cabin environment of the vehicle 10 recently changed. Thus, if there is not an environmental condition detected at the decision diamond 34, the algorithm determines if an alarm is active at decision diamond 36. If an alarm is not active, the algorithm returns to the decision diamond 34 to determine if there is an environmental condition as described above. If an alarm is active at the decision diamond 36, the alarm is disabled at box 38.

If an environmental condition that indicates an inhospitable environmental condition in the passenger cabin of the vehicle 10 exists at the decision diamond 34, the algorithm determines if an occupant is detected in the passenger cabin of the vehicle 10 at decision diamond 40. An occupant may be detected using seatbelt sensors, weight sensors, motion sensors, infrared camera, microphone, or the controller 16 may infer the presence of an occupant based on door openings, seatbelt activation, or by inference from changing oxygen and carbon dioxide levels as measured by an oxygen sensor and a carbon dioxide sensor. Presence may also be inferred based on the approximate location of a tracking enabled device of a vehicle user such as a cellular phone, smart watch, etc.

If an occupant is detected at the decision diamond 40, a channel is selected to inform a vehicle administrator or a driver of the environmental condition at box 42. A vehicle administrator or a driver may be informed using the communication device 20. For example, Bluetooth, WiFi, a dealer connection, a keyfob of the vehicle 10 that is in range, a text or call sent, OnStar®, RemoteLink®, etc., may be used to contact a vehicle administrator or a driver about the condition at the box 42. The communication sent may vary depending on what type of environmental condition is triggering the alert state. Furthermore, alerts may be tailored based on driver proximity via, for example, a keyfob or paired device within range. In addition to sending a communication as described above, diagnostic codes may be set based on the sensed condition, e.g., exhaust leak. The algorithm may take a more drastic measure to alert that an inhospitable condition exists at the box 42, such as an OnStar® alert or exterior vehicle alarm.

If an occupant is not detected, at box 44 a selected device or devices that are connected to the vehicle 10 via the wireless communications device 20 may be used to inform a vehicle administrator, for example a driver, of the environmental condition, e.g., via a ringtone or haptic notification to the driver's handheld device or computer such that the driver may decide what to do with the information. For example, if the sensors 12 or 14 detect ice cream has been left in the vehicle 10 and the temperature of the vehicle's passenger cabin rises above a threshold level, a driver's phone may be alerted via a ringtone, message and/or vibration to alert the driver that the temperature has risen to the threshold, thereby reminding the driver that they may wish to finish what they are doing and return to the vehicle 10. Alternatively, the vehicle 10 may use an exterior alarm (horn or audio) and/or flashing interior/exterior lights for an alert at the box 44.

At decision diamond 46 the algorithm determines if the environmental condition of the vehicle 10 has reached a threshold that triggers a countermeasure procedure to be enacted. If not, the algorithm returns to the decision diamond 34. If a countermeasure threshold has been achieved a variety of local control logic and remote/cloud control logic countermeasures may be taken at box 48. For example, for local control logic the controller 16 may cause the vehicle 10 to take a countermeasure such as initiating air conditioning. For example, the controller 16 may start an engine of the vehicle 10, roll down one or more windows and/or activate an HVAC system and engage a shift lock if the temperature of the vehicle reaches a predetermined threshold and if the sensors indicate that an occupant or perishable items are in the vehicle. Engaging the shift lock prevents the vehicle from being driven without a key, similar to known remote start systems. For an internal combustion engine vehicle, this may include logic that does not start the engine while running the HVAC system until a battery voltage of the vehicle drops to a critical value, at which time the engine may be started and the transmission may be locked to avoid potential vehicle theft. It is to be understood that certain vehicles cannot run an HVAC system using battery power alone, in which case the vehicle is started before the HVAC is turned on. For electric vehicles, the HVAC may be run until a specific battery margin threshold is reached, and the state of the battery may be communicated to a vehicle administrator as stated above. Alternatively, in a life threatening condition, the HVAC may be operated until the battery of the electric vehicle is exhausted. Additionally, using the HMI 18 or a remote device, a user could set preferences such that only a specific area is cooled. For example, in the case of perishable items left in the vehicle 10, a user may set preferences such that only the glove box, console or trunk is cooled. To determine if perishable items are present, RFID tags that are associated with the items may be read by the sensors 12 and 14. An example of remote control logic countermeasures that the algorithm of the controller 16 may take is to send the conditions of the vehicle 10 to a monitoring system such as OnStar® to enable the remote control logic of OnStar® to determine when to take a countermeasure and what countermeasure to take.

The controller 16 may wake-up and periodically check environmental conditions in the vehicle 10 when the vehicle is in a power off mode. The time between wake-up periods may be lengthened or shorted as warranted by the conditions using built-in logic of the controller 16. For example, if the environmental conditions of the vehicle 10 have been favorable for a predetermined previous number of wake-ups, the next wake-up of the controller 16 may be delayed. Alternatively, if environmental conditions in the passenger cabin of the vehicle 10 are approaching unfavorable conditions or if a rate of change of known forecasts/conditions indicate unfavorable vehicle environmental conditions in the near future, the time between wake-ups of the controller 16 may be decreased.

For example, the algorithm described above may utilize the communications link 20 to alert a user's smartphone or similar handheld device via an application/email/text when a threshold environmental condition has been crossed. If the user does nothing in a predetermined time interval, e.g., five minutes, or if a specified delta level (change) in the environmental condition is achieved, the algorithm may resort to a default action such as opening windows and/or turning on a fan. In addition to taking the default action, another alert may be sent to the user. The alert sent to the user may include what action has already been taken and what will be the next step(s) taken as well as the conditions that will prompt the next step(s) taken. Thus, the user may decide whether to intervene or implicitly approve the proposed next step(s) by doing nothing.

If there is still no response from the user, the algorithm may start emergency flashers and send emails/texts to second level contacts, depending on the severity of the condition(s). For example, a 911 call will go out for life-threatening conditions but not for perishing groceries. A next level of escalation may be to call local emergency responders, e.g., 911, with GPS coordinates of the vehicle if the environmental condition(s) persist.

A user has the option to turn off further notifications and other corrective actions for a specified period of time using the HMI 18 or a smartphone or similar device using an application. This is provided to avoid nuisance warnings when a vehicle is parked and does not have any occupants inside. Furthermore, the controller 16 may be programmed such that monitoring will cease if a user has not returned to the vehicle 10 for an extended period of time, e.g., a day or more. Additionally, the sensor data may also be used to pre-condition the vehicle 10 for use, e.g., instead of turning off a remote-started vehicle after 5 minutes, the vehicle may be kept running until the passenger cabin environment is within pre-set thresholds.

As will be well understood by those skilled in the art, the several and various steps and processes discussed herein to describe the invention may be referring to operations performed by a computer, a processor or other electronic calculating device that manipulate and/or transform data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

1. A system for monitoring and responding to environmental conditions in an interior portion of a vehicle, said system comprising:
a plurality of sensors that monitor environmental conditions in the interior portion of the vehicle;
a human-machine interface that allows a user to set or modify thresholds for the environmental conditions in the interior portion of the vehicle; and
a controller that is programmed to receive sensor signals and compile indexes that are based on one or more of the sensor signals, built-in control logic and a history of user preferences, said controller further programmed to determine when one or more of the thresholds for the environmental conditions has been or will be achieved, said controller further programmed to provide escalating measures to notify the user, a third party, or a combination thereof, that one or more of the thresholds has been reached or will be reached, said controller further programmed to provide countermeasures when one or more of the thresholds has been reached or before it will be reached.

2. The system according to claim 1 wherein the plurality of sensors include temperature, oxygen, carbon monoxide, carbon dioxide, ultraviolet radiation, allergens, occupant detection, and trunk contents detection sensors.

3. The system according to claim 1 wherein the plurality of sensors may be sensors that are part of the vehicle, sensors that are added to the vehicle using a plug-in device, sensors that may be carried on the person of one or more occupants, or a combination thereof.

4. The system according to claim 1 wherein the human machine interface is part of the vehicle.

5. The system according to claim 1 further comprising a communications link.

6. The system according to claim 5 wherein the human machine interface is a handheld device that communicates with the vehicle using the communications link.

7. The system according to claim 1 wherein the third party that may be contacted includes OnStar®, a user, emergency personnel, or some combination thereof.

8. The system according to claim 1 wherein countermeasures include using the vehicle to remedy the environmental condition.

9. The system according to claim 1 wherein escalating countermeasures are taken when an occupant or a pet are detected to be at risk of injury in the vehicle, perishable items are detected in the vehicle, or a combination thereof.

10. A system for monitoring and responding to environmental conditions in an interior portion of a vehicle, said system comprising:
a plurality of sensors that monitor environmental conditions in the interior portion of the vehicle; and
a controller that is programmed to receive sensor signals and compile indexes based on one or more of the sensor signals, built-in control logic and a history of user preferences, said controller further programmed to determine if one or more predetermined threshold environmental conditions has been or will be reached, said controller further programmed to provide escalating countermeasures when one or more of the predetermined thresholds has been or will be reached.

11. The system according to claim 10 wherein the plurality of sensors include temperature, oxygen, carbon monoxide, carbon dioxide, ultraviolet radiation, allergens, occupant detection, and trunk contents detection sensors.

12. The system according to claim 10 wherein the plurality of sensors are sensors that are part of the vehicle, sensors that are added to the vehicle using a plug-in device, sensors that are a part of a device carried on the person of one or more occupants, or a combination thereof.

13. The system according to claim 10 further comprising a human machine interface that is part of the vehicle, is in communication with the vehicle, or some combination thereof, wherein the human machine interface is used to set predetermined thresholds and allow a user to respond to alerts regarding the environmental conditions of the vehicle.

14. The system according to claim 10 wherein the countermeasures include contacting OnStar®, a user, emergency personnel, or some combination thereof.

15. The system according to claim 10 wherein the countermeasures include using the vehicle to remedy the environmental condition.

16. A method for monitoring and responding to environmental conditions in an interior portion of a vehicle, said system comprising:
providing a plurality of sensors that monitor environmental conditions in the interior portion of the vehicle; and
providing a controller that is programmed to receive sensor signals and compile indexes based on one or more of the sensor signals, built-in control logic and a history of user preferences, said controller further programmed to determine if one or more predetermined threshold environmental conditions has been reached, said controller further programmed to provide escalating countermeasures when one or more of the predetermined thresholds has been reached or to prevent the predetermined thresholds from being reached.

17. The method according to claim 16 wherein providing the plurality of sensors includes providing sensors such as temperature, oxygen, carbon monoxide, carbon dioxide, ultraviolet radiation, allergens, occupant detection, and trunk contents detection sensors.

18. The method according to claim 16 wherein providing the plurality of sensors includes providing sensors that are part of the vehicle, sensors that are added to the vehicle using a plug-in device, sensors that are part of a device carried on the person of one or more occupants, or a combination thereof.

19. The method according to claim 16 further comprising providing a human machine interface that is part of the vehicle, is in communication with the vehicle, or some combination thereof, wherein the human machine interface is used to set predetermined thresholds and allow a user to respond to alerts regarding the environmental conditions of the vehicle.

20. The method according to claim 16 wherein providing countermeasures include contacting OnStar®, a user, emergency personnel, or some combination thereof.

21. The method according to claim 16 wherein countermeasures include using the vehicle to remedy the environmental condition.
